(19) United States
(12) Patent Application Publication
(10) Pub. No.: US 2010/0294602 A1
(43) Pub. Date: Nov. 25, 2010

(54) PARKING BRAKE SYSTEM

(75) Inventors: Magnus GUSTAFSSON, Lodose (SE); Stefan SAND, Hjaertum (SE); Robbie CANNON, Clio, MI (US)

Correspondence Address: INGRASSIA FISHER & LORENZ, P.C. (GME), 7010 E. COCHISE ROAD, SCOTTSDALE, AZ, 85253, US

(73) Assignee: GM GLOBAL TECHNOLOGY OPERATIONS, INC., Detroit, MI (US)

(21) Appl. No.: 12/775,390

(22) Filed: May 6, 2010

(30) Foreign Application Priority Data
May 21, 2009 (GB) 0908743.8

(51) Int. Cl. B60T 8/171; B60R 21/015

(52) U.S. Cl. 188/158

(57) ABSTRACT

An electromechanically operable parking brake system is provided for motor vehicles as well as to a respective method of operation The system includes, but is not limited to a brake device that is lockable by a brake module, a control unit that is electrically coupled to the brake module and further adapted to generate a first control signal for generating a first brake application force, and a safeguard mechanism is adapted to generate a second control signal for applying a second brake application force. The second brake application force is larger in magnitude than the first brake application force.

### CROSS-REFERENCE TO RELATED APPLICATION

This application claims priority to British Patent Application No. 0908743.8, filed May 21, 2009, which is incorporated herein by reference in its entirety.

### TECHNICAL FIELD

The technical field relates to electromechanically operable parking brake systems for motor vehicles as well as to a motorized vehicle equipped with such a parking brake system. The technical field further relates to a method of operating of an electromechanically operable parking brake system.

### BACKGROUND

In electromechanically operable parking brake systems, a drive means, typically in form of an electric motor, is adapted to apply a load to a brake module. The magnitude of this load or brake application force provided by such a brake module has to be in a range, in which a vehicle is sufficiently secured against unintentional movement.

In many electromechanically operable parking brake systems, the parking brake is activated and/or released by pressing of a respective parking brake button or switch. When applied, the electromechanical drive, the brake module, typically generates a maximum applicable load to the brake device. When applying the parking brake always with a maximum available brake application force, the brake caliper as well as a mechanical force transmission system, such as bowden cables and the like, become always subject to a maximum load, which requires a correspondingly robust and hence correspondingly cost-intensive design of the various components of the parking brake system.

Document DE 198 14 657 A1 discloses for instance a hill-inclination sensor, which serves as a setpoint device and which allows for a load reduction of the mechanical components of a parking brake system. In this approach, the applied load varies with a detected hill-inclination or longitudinal inclination of the motorized vehicle.

Even though electromechanically operable parking brake systems provide a manifold of functions, such as automatic or semi-automatic activation and release modes, the end-user may still be unsatisfied with the general handling of such parking brakes since these systems do not provide manual and/or gradual application or release of electromechanically operated parking brakes.

In view of the foregoing it is therefore at least one object to provide an electromechanically operable parking brake system featuring an intuitive, secure, unambiguous and user-friendly handling. Additionally, an increased lifetime of caliper and force transmission system of an electromechanically operable parking brake is provided and an intention to reduce power consumption required for parking brake application.

### SUMMARY

An electromechanically operable parking brake system is provided for motorized vehicles and comprises at least one brake device being lockable by a brake module. The brake device is typically designed as brake caliper of a disc or drum brake, whereas the brake module serves as electromechanical drive, which is adapted to generate a required mechanical load to be applied to the brake device.

The parking brake system further comprises a control unit, which is electrically coupled to the brake module. The control unit is adapted to generate various control signals that correspond to respective brake application forces to be generated by the brake module and to be applied to the respective brake device. The control unit is adapted to generate at least a first control signal for generating a corresponding first brake application force.

The parking brake system further comprises a safeguard mechanism, which is adapted to generate a second control signal for applying a second brake application force to the brake device. The second brake application force is larger in magnitude than the first brake application force. In this way, the electromechanical operable parking brake system provides a gradual and/or stepwise application or actuation of a parking brake. In typical implementations, the first brake application force corresponds to a default brake application, whereas a second and larger brake application force is only occasionally applied, e.g., upon request or if required.

In many situations, e.g., when the motor vehicle is parked on even ground, locking of the brake device by applying the first brake application force may already be sufficient in order to secure the motorized vehicle against unintentional or self-actuating movement. This way the general brake application force can be reduced compared to the maximum available brake application force. Correspondingly, the mechanical load and strain acting on a force transmission system, which mechanically couples the brake device and the brake module, can be advantageously reduced to a moderate magnitude. By way of the brake application force reduction, lifetime of the force transmission system, such as bowden cables as well as the lifetime of the brake device itself can be prolongated. Moreover, application of a reduced brake application force also reduces electric power consumption and helps to safe fuel.

Application of the second brake application force is governed by the safeguard mechanism. Application of the second and larger brake application force can be initiated on demand or autonomously, in particular when various predefined conditions are met. In this way, a default brake application force can be stepwise or gradually increased in order to cope with boundary conditions and/or variable demands of a user.

According to a first preferred embodiment, the magnitude of the first and/or second brake application force depends on a longitudinal inclination of the vehicle. In this way, depending on whether the vehicle is parked at an inclination or on uneven ground, the magnitude of first and/or second brake application force correspondingly varies. In this way, the parking brake system may autonomously adapt to varying environmental conditions. It can be further asserted, that even by application of a moderate and a reduced default first brake application force, the vehicle will not become subject of an autonomous and unintentional movement.

In a further preferred embodiment, the magnitudes of first and second brake application forces differ by a predefined value. The magnitude of first and second brake application forces may be scaled in discrete steps. Moreover, brake application is not generally limited to application of first and second brake application forces. It is conceivable, that the control unit generates a sequence of numerous control signals corresponding to a stepwise and/or gradual increase of the brake application force to be applied to the brake device. The difference between successive brake application forces might be constant or may even be subject to modifications. The difference in successive brake application forces might be further defined as a function of the magnitude of the applied force itself.

In a further embodiment of the invention, the difference in magnitude between first and second brake application forces depends on the longitudinal inclination of the vehicle. Additionally or alternatively, the difference in magnitude as well as the magnitude of first and second brake application forces itself may also depend on other external parameters, such as system-inherent clearance and/or wear of the brake device and its various components, such as brake linings, brake drums and/or brake discs.

According to another preferred embodiment, the second control signal for application of the second and enlarged brake application force is generated on a user's demand. Generation of the second control signal can for instance be initiated by repeated actuation of a respective actuation device, such as a button or switch. Alternatively, it is conceivable, that generation of first and second control signals can be separately and independently generated by actuation of respective first and second buttons or switches.

According to another preferred embodiment, the second control signal, which is adapted to increase the brake application force, is generated in response to a user leaving the vehicle. Leaving of the vehicle can be sensed and detected in a manifold of different ways. Irrespective of a detection mechanism, generation of said second control signal and application of a respective increased second brake application force helps to ensure, that the vehicle will not autonomously set in motion, e.g., when the vehicle is parked at an inclination.

Leaving of the vehicle can for instance be detected by a removal of an ignition key, in response to a seat belt release and/or in response to an opening and/or closing of a vehicle door. Additionally, it is conceivable to make use of seat pressure sensors indicating whether a vehicle seat is occupied by a passenger.

According to another preferred embodiment of the invention, the second control signal is generated in response to failure detection, in particular in response to a failure in the electric parking brake control circuit. In this way, the parking brake system provides a kind of failsafe mode, which is typically initiated and triggered by failure information, e.g., provided by a CAN bus of the vehicle. It has turned out in practice that one of the most frequent failures occurs with electrical connectors and switches on the control side of the parking brake system, whereas the power circuit side as well as the mechanical force transmission system between brake module and brake device is rather robust and less prone to failure.

According to a further preferred embodiment, the brake module is adapted to generate a maximum brake application force in response to the second control signal. In this embodiment, the applied brake application force is then increased to the maximum available brake application force. Such an operation mode is for instance beneficial, when a failure has been detected in the parking brake system.

In other application scenarios or in normal operation mode, it is conceivable, that the default first brake application force is only stepwise or gradually increased by generation of the second control signal. In effect, the second brake application force does not necessarily have to correspond to the maximum available brake application force.

In another independent aspect, the invention further provides a motor vehicle being equipped with the electromechanically operable parking brake system.

In a further independent aspect, a method is provided for operating an electromechanically operable parking brake system for motor vehicles. Here, in a first step, at least one brake device, e.g., a brake caliper is locked or activated by a brake module, which generates a first brake application force in response to a first control signal received from a control unit. The control unit is adapted to generate the control signals and is electrically coupled to the brake module.

In a second, successive step, a second brake application force is applied to the brake device in response to a respective second control signal, which is generated by a safeguard mechanism.

The safeguard mechanism can be implemented as a separate module to be coupled with the control unit. The safeguard mechanism may also be entirely integrated with the control unit.

The second brake application force is larger in magnitude than the first brake application force. In this way, the safeguard mechanism provides increased security and serves to prevent unintentional movement of the vehicle.

In a preferred embodiment, the second and enhanced brake application force is generated in response to a user's demand. In this way, a user of the vehicle is provided with enhanced control means allowing for a precise and entirely user-governed application of an electrical parking brake.

Additionally or alternatively, according to a further embodiment, it is conceivable, that the second brake application force is generated in response to a removal of an ignition key, in response to a seat belt release and/or in response to an opening and/or closing of a vehicle door. Additionally, signals of a seat pressure sensor can be evaluated for detecting whether a user leaves the vehicle.

In a further embodiment, the method of operating may also include a failsafe mode, wherein the second and enlarged brake application force is generated in response to a failure detection. Typically, in such failure detection mode, the second brake application force may substantially correspond to a maximum available brake application force to be generated by the brake module.

### BRIEF DESCRIPTION OF THE DRAWINGS

The present invention will hereinafter be described in conjunction with the following drawing figures, wherein like numerals denote like elements, and:

FIG. 1 shows a diagram illustrating the parking brake system in a first operation mode;

FIG. 2 shows a diagram illustrating a second operation mode; and

FIG. 3 schematically illustrates the various components of the electric parking brake system in a block diagram.

### DETAILED DESCRIPTION

The following detailed description is merely exemplary in nature and is not intended to limit application and uses. Furthermore, there is no intention to be bound by any theory presented in the preceding background or summary or the following detailed description.

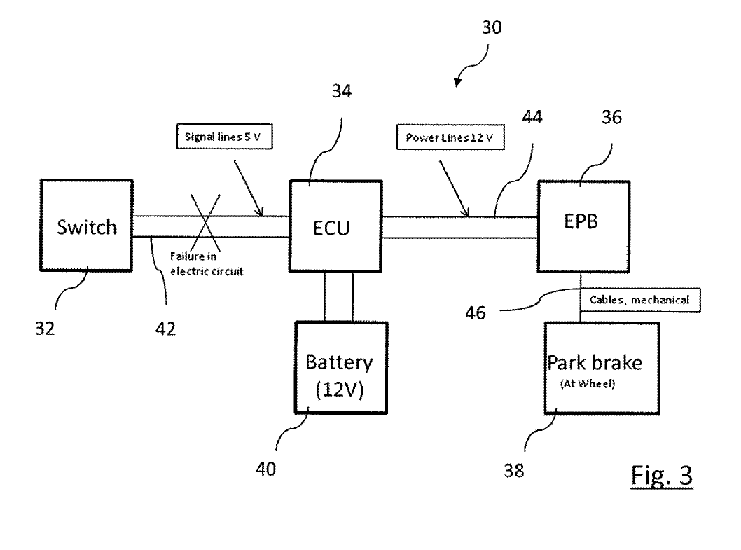

The electromechanically operable parking brake system 30 as schematically illustrated in the block diagram of FIG. 3 comprises a brake device 38, typically interacting with a brake disk or brake drum of a vehicle wheel. The brake device 38 may comprise a brake caliper in order to transfer a brake force to the respective wheel of the vehicle.

The brake device 38 is mechanically coupled to a brake module 36 by means of a force transmission system 46, e.g., by means of bowden cables or comparable mechanical force transmission means. The brake module 36 is adapted to generate sufficient brake application forces in response to respective control signals generated by the electronic control unit 34. The control unit 34 and the brake module 36 are electrically coupled by means of a power line 44. The control unit 34 may therefore serve as a switch to feed the brake module 36 with electrical energy provided by a power supply, e.g., a battery 40. The control unit 34 further provides a coupling of a control side and a power side of the parking brake system.

The control unit 34 is further coupled to a switch 32 by means of electrical signal lines 42. In contrast to the power line 44, electrical signal lines 42 are adapted and designed for a lower electrical power regime.

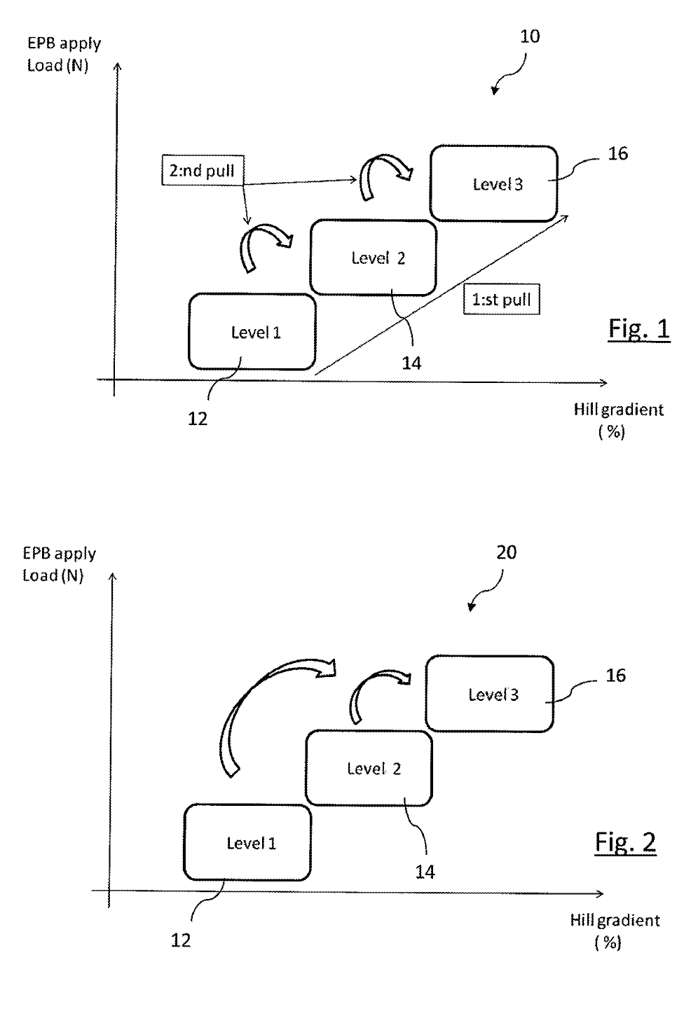

In the diagrams 10, 20 in FIG. 1 and FIG. 2, a mechanical load applied to the brake device 38 is illustrated in vertical direction versus a hill-inclination in horizontal direction. The substantially rectangular boxes 12, 14, 16 correspond to different brake application forces. In the illustrated embodiments of FIG. 1 and FIG. 2, three different discrete brake application forces 12, 14 or 16 can be selected.

In FIG. 1, a hill-inclination functionality is schematically depicted. If the parking brake is actuated for the first time, depending on an actual longitudinal inclination of the vehicle, the parking brake system will autonomously select an applicable load level 12, 14, 16 as first brake application force. In a successive step, e.g., when the user repeatedly actuates the parking brake, the system then stepwise increases the brake application force.

If for instance the vehicle has been parked on even ground, in response to a first actuation of the parking brake, the lowest load level 12 will be selected. If the passenger then decides to leave the vehicle or decides to increase the brake application force by repeatedly actuating a respective switch 32 or button, the parking brake system, in particular the control unit 34 will generate a second control signal leading to a respective increase in the brake application force. The system then switches to a higher load level 14.

In another conceivable scenario, where the vehicle is parked at an inclined hill, in response to a first actuation of the switch 32, the system may already select the intermediate or second highest level 14 as default first brake application force. Then, in response to a second activation of the switch 32 or triggered by e.g. a detection of ignition key removal, seat belt release and/or door opening, the parking brake system may autonomously switch to the highest brake application force level 16 for safety reasons.

The operation mode as illustrated in FIG. 1 is wherein the safeguard mechanism serves to increase a default brake application force always to the next higher applicable level.

In contrast to that, in the application mode as illustrated in FIG. 2, a repeated application of the parking brake always leads to an increase to the maximum available brake application force 16. This brake application force increase is typically triggered in situations, where a user is leaving the vehicle. The increase in brake application force according to FIG. 2 might be for instance triggered by removal of an ignition key or comparable authorization device, in response to seat belt release and/or in response to an opening and/or closing of a vehicle door.

Additionally or alternatively, the autonomous increase of the brake application force to the maximum value 16 might be triggered by signals obtainable from seat pressure sensors.

Furthermore, but not particularly illustrated, the invention also provides a failsafe mode. If for instance a failure is detected in the electrical signal line 42 which electrically connects the switch 32 and the control unit 34, the parking brake system may switch to a failsafe mode, such that the highest available brake application force level 16 is applied, irrespective of other internal or external conditions.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. An electromechanically operable parking brake system for a motor vehicle comprising:
a brake device that is lockable by a brake module;
a control unit electrically coupled to the brake module and adapted to generate a first control signal for generating a first brake application force; and
a safeguard mechanism adapted to generate a second control signal for applying a second brake application force, wherein the second brake application force is larger in magnitude than the first brake application force.

2. The electromechanically operable parking brake system according to claim 1, wherein the magnitude of the first brake application force depends on a longitudinal inclination of the vehicle.

3. The electromechanically operable parking brake system according to claim 1, wherein the magnitude of the second brake application force depends on a longitudinal inclination of the vehicle.

4. The electromechanically operable parking brake system according to claim 1, wherein the magnitude of first brake application force and the second brake application force differ by a predefined value.

5. The electromechanically operable parking brake system according to claim 1, wherein the difference in magnitude between the first brake application force and the second brake application force depends on a longitudinal inclination of the motor vehicle.

6. The electromechanically operable parking brake system according to claim 1, wherein the second control signal is generated based upon a request from a user.

7. The electromechanically operable parking brake system according to claim 1, wherein the second control signal is generated in response to a user leaving the motor vehicle.

8. The electromechanically operable parking brake system according to claim 1, wherein the second control signal is generated in response to a removal of an ignition key.

9. The electromechanically operable parking brake system according to claim 1, wherein the second control signal is generated in response to a seat belt release

10. The electromechanically operable parking brake system according to claim 1, wherein the second control signal is generated in response to an opening of a vehicle door.

11. The electromechanically operable parking brake system according to claim 1, wherein the second control signal is generated in response to a closing of a vehicle door.

12. The electromechanically operable parking brake system according to claim 1, wherein the second control signal is generated in response to a failure detection.

13. The electromechanically operable parking brake system according to claim 1, wherein the brake module generates a maximum brake application force in response to the second control signal.

14. A method of operating of an electromechanically operable parking brake system for a motor vehicle, comprising the steps of:
locking a brake device with a brake module;
generating a first brake application force in response to a first control signal generated by a control unit electrically coupled to the brake module; and
applying a second brake application force to the brake device in response to a second control signal generated by a safeguard mechanism,
wherein the second brake application force is larger in magnitude than the first brake application force.

15. The method according to claim 14, wherein the second brake application force is generated in response to a demand from a user.

16. The method according to claim 14, wherein the second brake application force is generated in response to a removal of an ignition key.

17. The method according to claim 14, wherein the second brake application force is generated in response to a seat belt release.

18. The method according to claim 14, wherein the second brake application force is generated in response to an opening or closing of a vehicle door.

19. The method according to claim 14, wherein the second brake application force is generated in response to a failure detection.

20. A motor vehicle, comprising:
a brake module;
a brake device that is lockable by the brake module;
a control unit electrically coupled to the brake module and adapted to generate a first control signal for generating a first brake application force; and
a safeguard mechanism adapted to generate a second control signal for applying a second brake application force, wherein the second brake application force is larger in magnitude than the first brake application force. an electromechanically operable parking brake system according to any one of the preceding claims.
